(19) United States
(12) Patent Application Publication
(10) Pub. No.: US 2012/0073915 A1
(43) Pub. Date: Mar. 29, 2012

(54) NOISE-DAMPING DISC BRAKE SHIM SYSTEM

(76) Inventors: STEWART KAHAN, Dollard Des Ormeaux (CA); Ken Schouten, Vaudreuil-Dorion (CA); Seong Kwan Rhee, Northville, MI (US)

(21) Appl. No.: 13/243,394

(22) Filed: Sep. 23, 2011

(30) Foreign Application Priority Data
Sep. 24, 2010 (CA) 2,715,608

(51) Int. Cl. F16D 65/097

(52) U.S. Cl. 188/73.37

(57) ABSTRACT

The present invention is a noise-damping shim system for use with disc brakes to dampen vibrational noise, or brake squeal. The system includes an inner shim, or noise damper, for placement between the piston and inner brake pad backing plate, where the outer surface of the inner shim adjacent to the piston has a relatively low coefficient of friction, and an outer shim, for placement between the caliper housing and outer brake pad backing plate, where the outer surface of the outer shim has a relatively high coefficient of friction. The outer surface of the inner shim may have a coefficient of friction of between 0.05 and 0.4. The outer surface of the outer shim may have a coefficient of friction of between 0.5 and 1.0. The shims may be single layer or multi-layer and composed of metal and elastomeric material or fabric, optionally with coatings such as polytetrafluoroethylene.

### FIELD OF THE INVENTION

The invention relates to automotive brakes, and more particularly relates to noise-damping shims for disc brake systems.

### BACKGROUND OF THE INVENTION

In a disc brake caliper, a hydraulically actuated piston forces, by action and reaction, a pair of opposing brake pads to pinch a rotor attached to, and rotating with, a vehicle wheel. Each brake pad has a stiff backing plate with a friction pad affixed to the inner side of the plate. The backing plate of the outer brake pad is attached to the caliper housing. The backing plate of the inner brake pad is proximate to the piston so that the piston, when actuated, moves the brake pads towards each other so that the friction pads engage the friction surfaces of the rotor such that the resulting frictional forces reduce the rotational speed of the rotor, and hence wheel.

A shim of a thin material is often used on the outer side of each plate. The shim on the outer brake pad (the “outer shim”) is in contact with the caliper housing, and the shim on the inner brake pad (the “inner shim”) is contacted by the piston. The caliper is secured to a support member of the vehicle. Typically a shim is a steel plate with thin layer of synthetic rubber, which may be, for example, 0.1 millimeters thick. The rubber layer may be further coated with a coating to reduce the coefficient of friction.

The shim's function is to reduce the frequency of occurrence of a loud and annoying squeal noise from what otherwise may be mechanically perfect brakes. Movement of the backing plate of the outer brake pad relative to the caliper housing and movement of the backing plate of the inner brake pad relative to the piston may cause squeal noise. At least some of the noise comes from the fact that, to prevent jamming, the backing plates have some freedom of radial movement within the caliper so that the rotor can be freed, while the piston has little freedom of movement.

In braking, the rigid rotor is frictionally engaged by the hard friction pads (which are in turn supported by their hard backing plates). The brake pads can frictionally slide to some degree against the rigid piston and caliper housing. High frictional forces are generated during this sliding movement which can cause squeal. Like a stick of chalk forced at an angle across a rigid board, friction can lead to very severe vibrational noise. As well, these recurring forces can lead to fretting and chipping of the piston rim. A great many designs of shims have been tried over the years to fit between the piston and the plate to reduce such friction and resulting squeal. None has been entirely satisfactory.

Brake squeal is an expensive problem for car and brake manufacturers as customers invariably want the noise remedied under warranty, even though the noise has no impact on the proper operation of the brakes to stop the car.

### SUMMARY OF THE INVENTION

The invention provides a noise-damping shim system for use in a disc brake having a caliper housing, inner and outer brake pads and a piston adjacent to the inner brake pad, the caliper housing having a caliper forcing member adjacent to the outer brake pad, the shim system comprising:
a. an inner shim for placement between the inner brake pad and the piston, the inner shim having a low friction outer surface to be placed adjacent to the piston; and
b. an outer shim for placement between the outer brake pad and the caliper forcing member, the outer shim having a high friction outer surface to be placed adjacent to the caliper forcing member.

The coefficient of friction of the low friction outer surface of the outer shim may be between 0.05 and 0.4 and the coefficient of friction of the high friction outer surface of the inner shim may be between 0.5 and 1.0. In a preferred embodiment, the coefficient of friction of the low friction outer surface of the inner shim is between 0.05 and 0.2 and the coefficient of friction of the high friction outer surface of the outer shim is between 0.75 and 1.0.

The inner shim may be a single metal layer, which may have a thickness of between 0.4 millimeters and 0.8 millimeters.

The outer shim may be a single layer of elastomeric material, which may have a thickness of between 0.2 millimeters and 0.8 millimeters.

The inner shim may comprise an outer layer of metal providing the low friction outer surface and an inner layer of elastomeric material. The thickness of the metal may be 0.1 millimeters to 0.5 millimeters and the thickness of the elastomeric material may be 0.2 millimeters to 0.5 millimeters. The outer layer of the inner shim may be coated with polytetrafluoroethylene.

The inner shim and outer shim may have the same composition such that the inner shim comprises an inner layer of metal and an outer layer of elastomeric material providing the high friction outer surface. The shim system may then be used in the disc brake wherein the inner shim is placed between the inner brake pad and the piston with the metal layer adjacent to the piston, and the outer shim is placed between the outer brake pad and the caliper forcing member, with the elastomeric material layer adjacent to the caliper forcing member.

### BRIEF DESCRIPTION OF THE DRAWINGS

FIG. 1 shows a cross-section of a brake caliper and piston assembly with the noise-damping shims installed.

FIG. 2 shows an exaggerated side view of a brake pad and piston assembly showing how a piston and brake pad may have a high-pressure contact point when the backing plate is dragged radially by the rotor causing the piston to cant slightly in the caliper cylinder.

FIG. 3 shows a cross-section of one embodiment of a multi-layer shim.

### DETAILED DESCRIPTION

FIG. 1 shows a sectioned brake caliper 1 with an inner brake pad and an outer brake pad mounted thereto. The inner brake pad comprises a backing plate 2 which has a bonded friction pad 3 adjacent to the brake rotor 6. The outer brake pad comprises a backing plate 4 which has a bonded friction pad 5 adjacent to the brake rotor 6. The inner shim 7, which may also be referred to as a noise damper, is located between the piston 9 and the inner brake pad backing plate 2. The outer shim 8 is located between the inner surface of the outer side of the caliper housing, referred to here as the caliper forcing member 10, and the outer brake pad backing plate 4. The caliper forcing member 10 may have a ventilation opening 14 as depicted in FIG. 1.

The caliper piston 9 has a hollow center 11 and slideably fits in the caliper cylinder 12 which is part of the caliper 1. The caliper 1 slideably connects to a caliper carrier and to a vehicle's suspension system via bosses 13 (only one shown). When the brake is applied, the piston 9 is forced from the cylinder 12, and, simultaneously, the caliper 1 is made to slide on caliper pins (not shown). This action causes the caliper forcing member 10 and piston 9 to approach each other, forcing the two opposing friction pads 3, 5 to pinch the rotor 6 thereby slowing its rotation because of the resulting friction.

In the absence of noise-damping shims, the movement of the backing plates 2, 4 against the piston 9 and caliper forcing member 10 when braking commonly causes brake squeal. However the mechanisms resulting in the squeal differ between the inner and outer brake pads and so the use of the same shim for the inner and outer pads with the same material adjacent to both the piston 9 and caliper forcing member 10 cannot be optimal for both pads. In that case, the shim may be optimized for one or the other or constitute a compromise, but in any case is still likely to perform sub-optimally and allow an unacceptable amount of squeal to continue to be produced.

To address this, different types of shims may be used for the inner and outer brake pads to take into account the differing causes of squeal. The use of an inner shim 7 with a relatively low coefficient of friction on the piston (outer) side of the shim and an outer shim 8 with a relatively high coefficient of friction on the caliper forcing member (outer) side of the shim is believed to provide significantly better noise suppression than the use of the same shim for both the inner and outer brake pads where the shims are configured to place their low friction surfaces adjacent to the piston and the caliper forcing member as is done in existing brake shim systems.

In general, the methods for attaching such shims to backing plates and the caliper housing are well known and any usual method may be employed.

In the simplest case, the inner shim 7 may be a single layer of metal, such as plain steel, on the inner brake pad backing plate 2, and the outer shim 8 may be a single layer of rubber, or other elastomeric material, adhered to the outer brake pad backing plate 4. In general the metal used may be ferrous or non-ferrous.

The outer surface of the inner shim 7, which contacts the piston 9, should have a coefficient of friction in the range 0.05 to 0.4, and the outer surface of the outer shim 8 in contact with the caliper forcing member 10 should have a coefficient of friction in the range 0.5 to 1.0. More preferably, the outer surface of the inner shim 7 should have a coefficient of friction in the range 0.05 to 0.2, and the outer surface of the outer shim 8 should have a coefficient of friction in the range 0.75 to 1.0.

In general, multi-layer shims are preferred so that the coefficient of friction of the inner surfaces of the shims that contact the backing plates 2, 4 can be chosen to be relatively high. Generally the layers of a multi-layer shim may be bonded via a heat-resistant adhesive or may be mechanically bonded. Such bonding methods are well known in the art.

In a preferred multi-layer embodiment, both the inner and outer shims 7, 8 may employ a high friction material forming their inner surface. The high friction material may be an elastomeric material, such as rubber or synthetic polyisoprene, or woven fabric, with a self-adhesive side that is attached to the backing plates 2, 4.

The outer shim 8 may be constructed with metal, such as steel, and an elastomeric material. The outer side, which will be the side in contact with the caliper forcing member 10, may have an elastomeric coating to produce a high friction effect, with a coefficient of friction between 0.5 and 1.0, between the outer brake pad assembly and the caliper forcing member 10. The high friction effect results in the damping of vibration and noise by minimizing the movement of the outer backing plate 4 against the caliper forcing member 10.

The inner shim 7 may be constructed with thin metal, such as steel, forming the outer surface. The inner shim 7 may employ a low friction coating or a smooth metallic material as the outside layer that will be in contact with the piston 9. This design allows movement between the piston contact surface and the inner brake pad backing plate 2 under braking pressure to permit the brake pad to locate itself while moving in the caliper housing before making contact with the rotor 6.

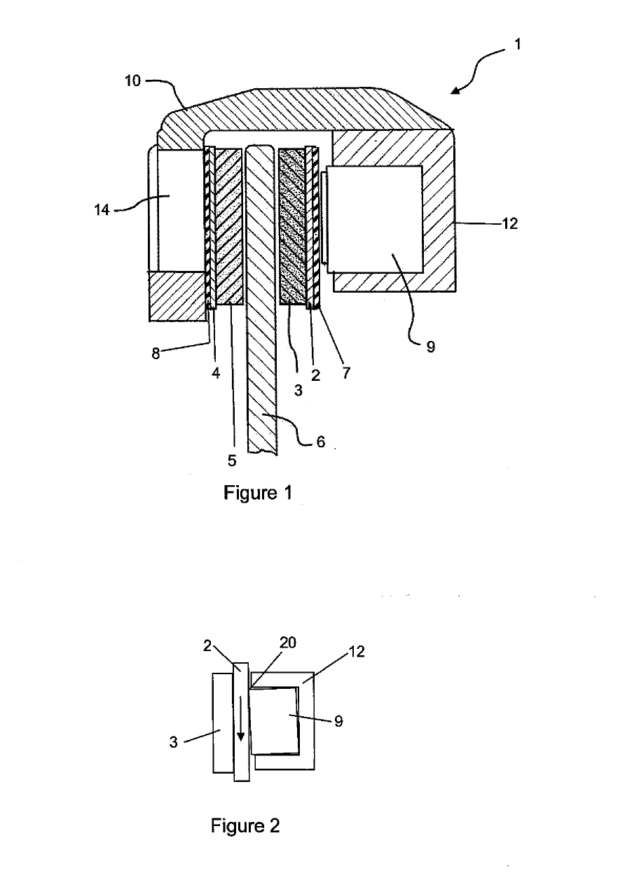

This may prevent the scenario shown in an exaggerated form in FIG. 2. If the backing plate 2 cannot readily move relative to the piston 9, then the braking pressure may result in side thrust on the piston 9, causing it to cant slightly in its cylinder 12 because of the small clearance between the piston 9 and cylinder 12. This may result in a high pressure contact point 20 that can damage the piston rim because of repeated high frictional forces, and also cause squeal. This may be avoided by the use of a low friction layer on the side of the inner shim 7 in contact with the piston 9 to permit some movement between the piston 9 and inner backing plate 2 to prevent the piston 9 from sticking to the backing plate 2 or inner shim 7. The inner brake pad can then move relatively freely during piston 9 movement so that the pad will not bind during movement and freely locate its friction surface against the rotor for maximum contact. Any binding or uneven contact of the friction surface and the piston 9 can be a source of noise, which is reduced or prevented by the present system.

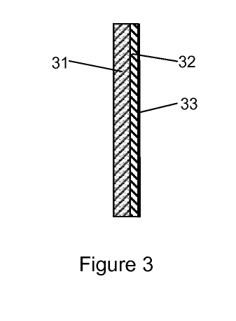

FIG. 3 shows a cross section of an example of a shim, which may be used as an inner shim 7, with a metal layer 32 which may be any smooth or painted metal. The metal layer 32 may optionally be further coated with a low-friction coating 33 such as Teflon® (polytetrafluoroethylene, or PTFE) to produce a very low coefficient of friction, such as 0.05, for the surface that will contact the piston 9. The inner high friction layer 31 may be an elastomeric material or fabric. Outer coatings and adhesive layers are typically 2 to 6 mil. Material thicknesses for metal and rubber layers are typically 0.2 millimeters to 0.3 millimeters each for multi layer constructions, although may be 0.1 millimeters to 0.5 millimeters or outside of this range. Single layer constructions are typically 0.4 millimeters to 0.6 millimeters thick with a 2 to 6 mil coating. For example, for a single layer metal shim, the shim may be made of 0.4 millimeters of steel with 3 mil adhesive on one side and 2 mil PTFE coating on the other. A multi layer shim may employ two 0.3 millimeters thick steel layers bonded with a 3 mil nitrile rubber adhesive layer in between, a 3 mil PTFE coating on one outer side and a 3 mil adhesive layer on the other outer facing side.

For the outer sides of the shims that contact the backing plates, the choice of material is less important, but is preferably a high friction elastomeric material. In general the materials used in the shims must be capable of withstanding high temperatures, so that anything that melts or degrades at temperatures above 450 degrees Celsius would not be suitable. For a high friction surface, on either the inner or outer shim, nitrile rubber, silicone rubber, Kevlar®, cotton, or a high friction coating on metal would be suitable materials. Other materials, such as glass fiber, inorganic filler, carbon and cork may be also be incorporated in a composite layer with an elastomeric material.

In a low cost embodiment, the shim system may employ the same physical shims for the inner shim 7 and outer shim 8 with one layer being metal, such as steel, and the other being an elastomeric material, such as rubber. In this case the inner shim 7 would be installed with the metal layer adjacent to the piston 9 and the outer shim 8 with the metal layer adjacent to the outer backing plate 5. While not providing performance as good as shims optimized for inner and outer use, this approach utilizes the key aspect of the invention whereby the coefficient of friction of the surface of the shim adjacent to the piston 9 is significantly less than that of the surface of the other shim adjacent to the caliper forcing member 10, but allows the same part to be used for both the inner and outer shim, thereby reducing manufacturing and inventory costs.

The foregoing description illustrates only certain preferred embodiments of the invention. The invention is not limited to the foregoing examples. That is, persons skilled in the art will appreciate and understand that modifications and variations are, or will be, possible to utilize and carry out the teachings of the invention described herein. Accordingly, all suitable modifications, variations and equivalents may be resorted to, and such modifications, variations and equivalents are intended to fall within the scope of the invention as described and within the scope of the claims. In particular, any stated thicknesses of materials in example embodiments of the invention described herein are only examples of suitable thicknesses; the invention is not limited by these examples, and thicknesses less than any stated lower limit or greater than any higher stated limit are generally possible and within the scope of the invention as it would be understood by a skilled person.

1. A noise-damping shim system for use in a disc brake having a caliper housing, inner and outer brake pads and a piston adjacent to the inner brake pad, the caliper housing having a caliper forcing member adjacent to the outer brake pad, the shim system comprising:
a. an inner shim for placement between the inner brake pad and the piston, the inner shim having a low friction outer surface to be placed adjacent to the piston; and
b. an outer shim for placement between the outer brake pad and the caliper forcing member, the outer shim having a high friction outer surface to be placed adjacent to the caliper forcing member.

2. The shim system of claim 1 wherein the coefficient of friction of the low friction outer surface of the outer shim is between 0.05 and 0.4 and the coefficient of friction of the high friction outer surface of the inner shim is between 0.5 and 1.0.

3. The shim system of claim 2 wherein the coefficient of friction of the low friction outer surface of the inner shim is between 0.05 and 0.2.

4. The shim system of claim 2 wherein the coefficient of friction of the high friction outer surface of the outer shim is between 0.75 and 1.0.

5. The shim system of claim 2 wherein the coefficient of friction of the low friction outer surface of the inner shim is between 0.05 and 0.2 and the coefficient of friction of the high friction outer surface of the outer shim is between 0.75 and 1.0.

6. The shim system of claim 1 wherein the inner shim is a single metal layer.

7. The shim system of claim 6 wherein the thickness of the metal is 0.4 millimeters to 0.8 millimeters.

8. The shim system of claim 1 wherein the outer shim is a single layer of elastomeric material.

9. The shim system of claim 8 wherein the thickness of the elastomeric material is 0.2 millimeters to 0.8 millimeters.

10. The shim system of claim 9 wherein the thickness of the elastomeric material is 0.4 millimeters to 0.6 millimeters.

11. The shim system of claim 1 wherein the inner shim comprises an outer layer of metal providing the low friction outer surface and an inner layer of elastomeric material.

12. The shim system of claim 11 wherein the thickness of the metal is 0.1 millimeters to 0.5 millimeters and the thickness of the elastomeric material is 0.2 millimeters to 0.5 millimeters.

13. The shim system of claim 11 wherein the outer layer of the inner shim is coated with polytetrafluoroethylene.

14. The shim system of claim 11 wherein the outer shim is a single layer of elastomeric material.

15. The shim system of claim 14 wherein the thickness of the outer shim is 0.2 millimeters to 0.8 millimeters, the thickness of the metal in the inner shim is 0.1 millimeters to 0.5 millimeters and the thickness of the elastomeric material in the inner shim is 0.2 millimeters to 0.5 millimeters.

16. The shim system of claim 11 wherein the inner shim and outer shim have the same composition such that the inner shim comprises an inner layer of metal and an outer layer of elastomeric material providing the high friction outer surface.

17. The use of the shim system of claim 16 in the disc brake wherein the inner shim is placed between the inner brake pad and the piston with the metal layer adjacent to the piston, and the outer shim is placed between the outer brake pad and the caliper forcing member, with the elastomeric material layer adjacent to the caliper forcing member.
